(19) United States
(12) Patent Application Publication
(10) Pub. No.: US 2009/0318893 A1
(43) Pub. Date: Dec. 24, 2009

(54) RECONSTITUTION AND ADMINISTRATION OF MEDICATION APPARATUS AND METHOD

(76) Inventor: MARY L. ENGLISH, Reno, NV (US)

Correspondence Address: James Ray & Associates, 2640 Pitcairn Road, Monroeville, PA, 15146, US

(21) Appl. No.: 12/489,645

(22) Filed: Jun. 23, 2009

Related U.S. Application Data
(60) Provisional application No. 61/074,750, filed on Jun. 23, 2008.

(51) Int. Cl. A61J 1/14; A61J 1/20

(52) U.S. Cl. 604/520; 604/83

(57) ABSTRACT

An apparatus for use in reconstituting and administering a predetermined medication into a patient's primary IV includes an IV bag containing a first predetermined amount of a predetermined fluid; a disposable pressure for at least partially enclosing such IV bag; means engageable with such pressure bag for applying pressure to such IV bag as directed by a user; a secondary intravenous tubing having a clamp member for permitting and terminating flow of fluids there through operably connectable to such IV bag at a first predetermined location; a plurality of vented cap mini spikes each operably connectable at a first end thereof to at least one of such secondary intravenous tubing, a syringe, and a combination thereof; and a syringe for drawing such reconstituted medicine into an interior portion therein and there after dispelling such predetermined amount of such reconstituted medicine into such patient's primary IV.

### CROSS REFERENCE TO RELATED APPLICATION

This patent application is related to and claims priority from U.S. Provisional Patent Application Ser. No. 61/074,750 filed Jun. 23, 2008.

### FIELD OF THE INVENTION

The present invention relates, in general, to reconstitution of medications and, more particularly, this invention relates to an apparatus and method for reconstitution and administration of medicine such as dantrolene sodium concentrates.

### BACKGROUND OF THE INVENTION

Prior to the conception and development of the present invention, medicines, as are generally well known in the prior art, are used to treat various ailments and health conditions. Specifically of interest to the present invention are the following: Fowles, et al, U.S. Pat. No. 7,074,216, discloses a reconstitution device for placing a first container, such as a liquid container (e.g. flexible container or syringe), in fluid communication with a second container, such as a drug vial. A connector device is provided for establishing fluid communication between the dilutent container and the drug vial.

Osborne, et al, U.S. Pat. No. 6,915,823, discloses an automated medication preparation system including automated syringe preparation that involves reconstitution of a medication. The system includes: (1) a first automated gripping means for removing a tip cap from a barrel of one syringe and placing the removed tip cap at a first location; (2) an automated device for delivering a prescribed dosage amount of medication to the syringe by delivering the medication through the uncapped barrel in a just-in-time for use manner; (3) a controller in communication with the automated device and including a database for storing reconstitution information that is executable with the automated device for reconstituting the medication prior to it being injected into the syringe, wherein the reconstitution information include at least a concentration of the resultant medication and a mixing time for agitating the medication; and (4) a second automated gripping means for replacing the removed tip cap.

Kamen, et al, U.S. Pat. No. 6,210,361, discloses a bedside-pharmacy system for the preparation and delivery of intravenous drugs. The system includes a liquid inlet for connection to a liquid supply, vial receptacles, and a liquid outlet for providing the intravenous drug in mixed, liquid form to the patient. The system may include a chamber having a variable volume, and a valve mechanism, which may be actuated to control flow between the liquid outlet, the variable-volume chamber, the vial receptacles and the liquid inlet. The system induces change in the volume of the variable-volume chamber and actuates the valve mechanism, so as to introduce liquid from the liquid inlet into the vials and reconstitute or dilute the drugs and so as to deliver the drugs to the patient.

Kaufman, U.S. Pat. No. 4,842,028, discloses an apparatus for the automated transfer of contents between a rubber diaphragm port-type vial and a flexible, collapsible bag for medical solutions; the bag has at least one needle-pierceable access port. A double-pointed hollow needle is positioned so that the vial is held with its rubber diaphragm facing one pointed end of the needle and the medical solution bag is held with its needle-pierceable access port facing the other pointed end of the needle. Apparatus is provided for bringing the vial and bag into needle-penetrated relation, to provide flow communication there between through the hollow needle. Means are also provided for compressing the bag to force liquid from the bag into the vial, and for releasing the compression to allow the liquid to flow from the vial back to the bag. As a result of this, the original contents of the vial may be carried into the bag in automated manner.

### SUMMARY OF THE INVENTION

The present invention provides an apparatus for use in reconstituting a predetermined medication and administering a predetermined amount of such reconstituted medication into a patient's primary IV. Such apparatus includes an IV bag containing a first predetermined amount of a predetermined fluid. A disposable pressure bag has a first predetermined size and a first predetermined shape for at least partially enclosing such IV bag. A means is engageable with such pressure bag for applying pressure to said IV bag selectively as directed by a user. A secondary intravenous tubing includes a clamp member operably connected thereto for permitting and terminating flow of fluids there through, such secondary intravenous tubing being operably connectable to such IV bag at a first predetermined location; A plurality of vented cap mini spikes are each operably connectable at a first end thereof to at least one of such secondary intravenous tubing at a second predetermined location, a syringe, and a combination thereof. A syringe is included for drawing such predetermined amount of such reconstituted medicine into an interior portion therein and there after dispelling such predetermined amount of such reconstituted medicine into such patient's primary IV.

A method of reconstituting a predetermined medication and administering a predetermined amount of such reconstituted medication into a patient's primary IV is provided. The method including the steps of: providing an apparatus for use in reconstituting a predetermined medication and administering a predetermined amount of such reconstituted medication into a patient's primary IV. Such apparatus includes: an IV bag containing a first predetermined amount of a predetermined fluid; a disposable pressure bag having a first predetermined size and a first predetermined shape for at least partially enclosing such IV bag; means engageable with such pressure bag for applying pressure to such IV bag selectively as directed by a user; a secondary intravenous tubing including a clamp member operably connected thereto for permitting and terminating flow of fluids there through, such secondary intravenous tubing being operably connectable to such IV bag at a first predetermined location; at least one vented cap mini spike operably connectable at a first end thereof to at least one of such secondary intravenous tubing at a second predetermined location, a syringe, and a combination thereof; and a syringe for drawing such predetermined amount of such reconstituted medicine into an interior portion therein and there after dispelling such predetermined amount of such reconstituted medicine into such patient's primary IV. Such method further includes the steps of providing a predetermined number of medicine vials each containing a predetermined amount of reconstitutable medicine therein and each having a covering member penetrable by a spike of a mini cap vented spike disposed thereon; closing such clamp on such secondary intravenous tubing; connecting such tubing to such IV bag; hanging such IV bag from a predetermined vertical support; opening then closing such clamp to prime such secondary intravenous tubing; placing such IV bag at least partially within such pressure bag; attaching a first vented cap mini spike to such secondary intravenous tubing; plunging a spike of such first vented cap mini spike through such cover of a first one of such plurality of vials; pumping such pressure bag to about 300 mm of Hg (mercury); opening such clamp to allow such predetermined fluid to enter such vial; closing such clamp when such vial is filled about 60-80% full of such predetermined fluid; shaking such vial gently to enhance reconstitution; repeating those steps with each of such plurality of vials until each vial is 60-80% full of such predetermined fluid; attaching a second vented cap mini to such syringe; drawing such reconstituted medicine from within a first vial into such syringe; releasing such second vented cap mini spike from such syringe; and injecting such reconstituted medicine into a predetermined patient's primary IV via such syringe. The above steps can be repeated for multiple vials of medication or multiple syringes if needed.

### OBJECTS OF THE INVENTION

It is, therefore, one of the primary objects of the present invention to provide a kit for use in quickly and efficiently reconstituting freeze dried medication.

Another object of the present invention is to provide a kit for use in reconstitution and administration of freeze dried dantrium.

Still another object of the present invention is to provide a kit which expedites the reconstitutions of medicines such as freeze dried dantrium.

Yet another object of the present invention is to provide a kit for use in reconstituting dantrium based medications and administering such reconstituted dantrium based medications.

An additional object of the present invention is to provide a kit containing all the components necessary to reconstitute and administer dried medications.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a general perspective drawing of a preferred embodiment of a kit containing all the components necessary to reconstitute and administer dried medications.

FIG. 2 is a general perspective drawing of a preferred embodiment of an assembled kit containing all the components necessary to reconstitute and administer dried medications.

FIG. 3 is a general perspective drawing of a preferred embodiment of an assembled kit containing all the components necessary to reconstitute and administer dried medications hanging from an IV stand.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

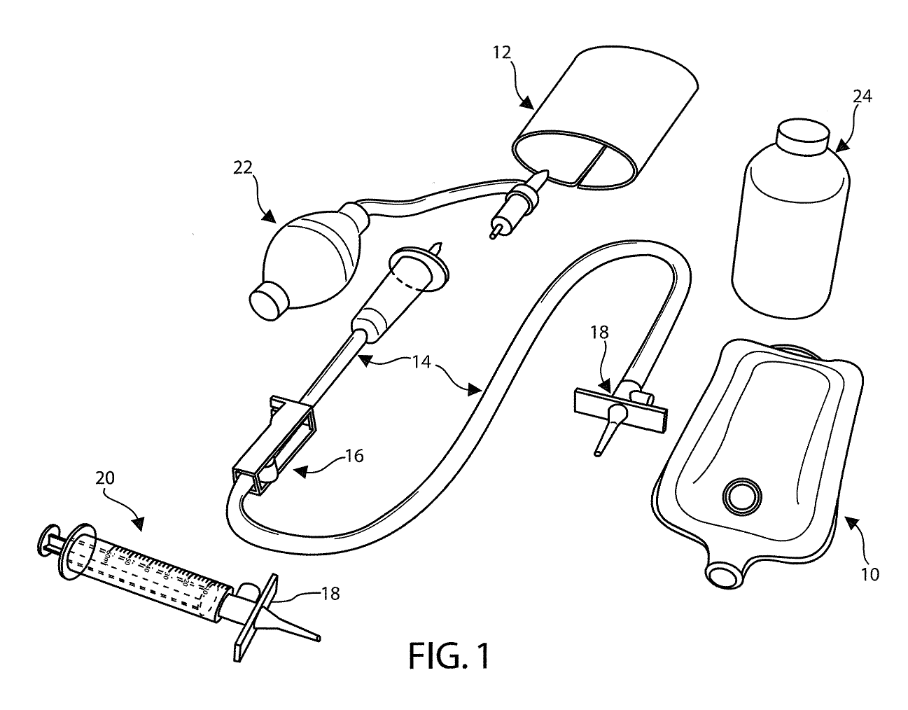

Reference is now made, more particularly, to FIG. 1 a general perspective drawing of a preferred embodiment of a kit containing all the components necessary to reconstitute and administer dried medications. The kit comprises an IV bag 10 containing approximately 1000 mL of sterile water; a disposable pressure bag 12 having a first predetermined size and a first predetermined shape for at least partially enclosing IV bag 10; a hand pump 22 engageable with pressure bag 12 for applying pressure to IV bag 10 selectively as directed by a user; secondary intravenous tubing 14 including a clamp 16 operably connected thereto for permitting and terminating flow of fluid there through, such secondary intravenous tubing 14 being operably connectable to IV bag 10; a plurality of vented cap mini spikes 18 are each operably connectable at a first end thereof to at least one of such secondary intravenous tubing 14 at a second predetermined location, a syringe 20, and a combination thereof; and dried medication vial 24, which could contain dantrolene sodium. A syringe 20 is included for drawing such predetermined amount of such reconstituted medicine into an interior portion therein and there after dispelling such predetermined amount of such reconstituted medicine into a patient's primary IV.

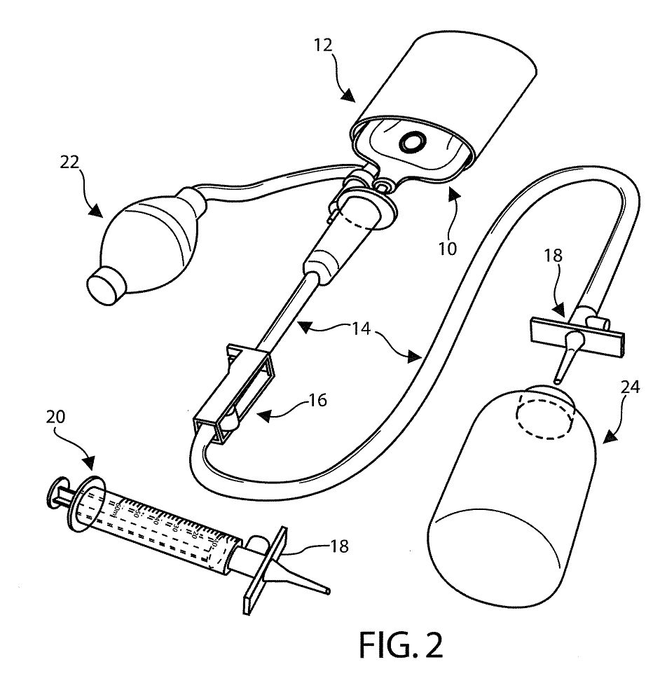

Reference is now made, more particularly, to FIG. 2 a general perspective drawing of a preferred embodiment of an assembled kit containing all the components necessary to reconstitute and administer dried medications. IV bag 10 containing approximately 1000 mL of sterile water is connected to on end of secondary intravenous tubing 14 including a clamp 16. IV bag 10 is inserted into disposable pressure bag 12 with a hand pump 22 engageable with pressure bag 12 for applying pressure to IV bag 10 selectively as directed by a user. Before applying pressure to IV bag 10 by means of pressure bag 12, secondary intravenous tubing 14 should be primed with fluid from IV bag 10. Once secondary intravenous tubing 14 is primed with fluid from IV bag 10, pressure can be applied to IV bag 10 by means of pressure bag 12 through use of hand pump 22 to a pressure of approximately 300 mm of Hg.

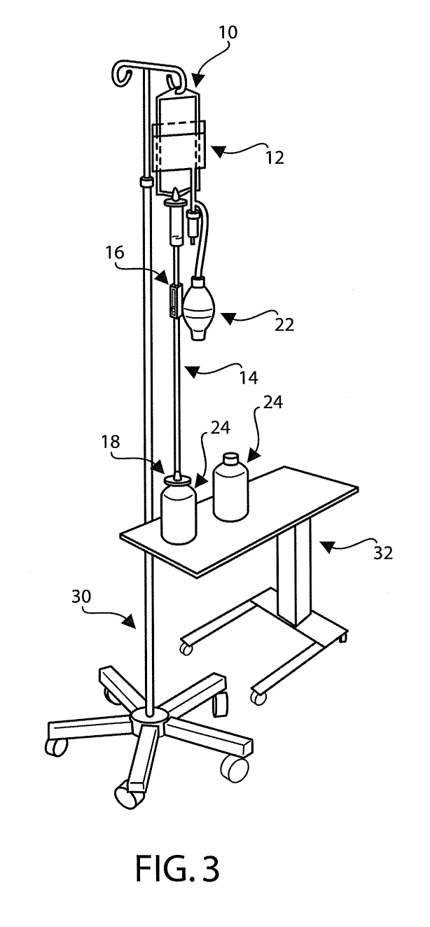

Reference is now made, more particularly, to FIG. 3 a general perspective drawing of a preferred embodiment of an assembled kit containing all the components necessary to reconstitute and administer dried medications hanging from an IV stand. Once the kit is assembled it can be hanged from IV stand 30 and dried medication vials 24 can be placed on a table 32 of appropriate height.

Viewing FIGS. 1-3 together a method of using the kit could proceed as follows.

Close clamp 16 on secondary intravenous tubing 14. Insert one end of secondary intravenous tubing 14 into IV bag 10 filled with 1000 mL of sterile water. Open clamp 16 to prime secondary intravenous tubing 14, close clamp 16 after priming. Insert IV bag 10 filled with 1000 mL of sterile water into pressure bag 12. Hang the assembly on IV stand 30, position table 32 to place the dried medication vials 24 on. Plunge the attached vented cap mini spike 18 into a dried medication vial 24. Pump hand pump 22 connected to pressure bag 12 until 300 mm of Hg of pressure is attained. Open clamp 16 and the sterile water will rapidly fill the dried medication vial 24 and mix the medication, shake gently to enhance mixing. Close the IV clamp when the vial is about 60-80% full. Pull vented cap mini spike 18 with attached secondary intravenous tubing 14 from dried medication vial 24 and plunge into the next dried medication vial 24 and repeat the filling process. Attach the 60 mL luer lock syringe 20 to a vented cap mini spike 18, invert the filled medication vial 24 and draw the reconstituted medication into the syringe 20. Disconnect the syringe 20 from the vented cap mini spike 18 and inject directly into the needle-less port of the patient's intravenous tubing.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An apparatus for use in reconstituting a predetermined medication and administering a predetermined amount of such reconstituted medication into a patient's primary IV, said apparatus comprising:
a. an IV bag containing a first predetermined amount of a predetermined fluid;
b. a disposable pressure bag having a first predetermined size and a first predetermined shape for at least partially enclosing said IV bag;
c. means engageable with said pressure bag for applying pressure there to said IV bag selectively as directed by a user;
d. a secondary intravenous tubing including a clamp member operably connected thereto for permitting and terminating flow of fluids there through, said secondary intravenous tubing being operably connectable to said IV bag at a first predetermined location;
e. a plurality of vented cap mini spikes each operably connectable at a first end thereof to at least one of said secondary intravenous tubing at a second predetermined location, a syringe, and a combination thereof; and
f. a syringe for drawing such predetermined amount of such reconstituted medicine into an interior portion therein and there after dispelling such predetermined amount of such reconstituted medicine into such patient's primary IV.

2. An apparatus according to claim 1 wherein said first predetermined fluid is sterile water.

3. An apparatus according to claim 1 wherein said syringe is a luer lock syringe.

4. An apparatus according to claim 1 wherein said interior portion of said syringe holds between about 40 ml and about 80 ml.

5. An apparatus according to claim 1 wherein said pressure bag is a 1000 ml pressure bag.

6. A method of reconstituting a predetermined medication and administering a predetermined amount of such reconstituted medication into a patient's primary IV, said method including the steps of:
a. providing an apparatus for use in reconstituting a predetermined medication and administering a predetermined amount of such reconstituted medication into a patient's primary IV said apparatus including:
i. an IV bag containing a first predetermined amount of a predetermined fluid;
ii. a disposable pressure bag having a first predetermined size and a first predetermined shape for at least partially enclosing said IV bag;
iii. means engageable with said pressure bag for applying pressure to said IV bag selectively as directed by a user;
iv. a secondary intravenous tubing including a clamp member operably connected thereto for permitting and terminating flow of fluids there through, said secondary intravenous tubing being operably connectable to said IV bag at a first predetermined location;
v. at least one vented cap mini spike operably connectable at a first end thereof to at least one of said secondary intravenous tubing at a second predetermined location, a syringe, and a combination thereof;
vi. a syringe for drawing such predetermined amount of such reconstituted medicine into an interior portion therein and there after dispelling such predetermined amount of such reconstituted medicine into such patient's primary IV;
b. providing a predetermined number of medicine vials each containing a predetermined amount of reconstitutable medicine therein and having a covering member penetratable by a spike of a mini cap vented spike diposed thereon;
c. closing said clamp on said secondary intravenous tubing;
d. connecting said tubing to said IV bag;
e. opening then closing said clamp to prime said secondary intravenous tubing;
f. placing said IV bag at least partially within said pressure bag;
g. hanging said IV bag from a predetermined vertical support;
h. attaching a first vented cap mini spike to said secondary intravenous tubing;
i. plunging a spike of said first vented cap mini spike through such cover of a first one of said plurality of vials;
j. pumping said pressure bag to a predetermined pressure;
k. opening said clamp to allow said predetermined fluid to enter said vial;
l. closing said clamp when said vial is filled to about 60 to 80 percent full of said predetermined fluid;
m. shaking said vial gently to enhance reconstitution;
n. repeating steps i through m with each of said plurality of vials until each vial is about 60 to 80 percent full of said predetermined fluid;
o. attaching a second vented cap mini to said syringe;
p. drawing such reconstituted medicine from within a first vial into said syringe;
q. releasing said second vented cap mini spike from said syringe; and
h. injecting said reconstituted medicine into a predetermined patient's primary IV via said syringe.

7. A method of reconstituting a predetermined medication and administering a predetermined amount of such reconstituted medication into a patient's primary IV according to claim 6, wherein said predetermined fluid substantially comprises water.

8. A method of reconstituting a predetermined medication and administering a predetermined amount of such reconstituted medication into a patient's primary IV according to claim 6, wherein said reconstitutable medicine comprises dantrolene sodium.

9. A method of reconstituting a predetermined medication and administering a predetermined amount of such reconstituted medication into a patient's primary IV according to claim 6, wherein said pressure bag is pumped to a predetermined pressure between about 100 mm of Hg and about 600 mm of Hg.

10. A method of reconstituting a predetermined medication and administering a predetermined amount of such reconstituted medication into a patient's primary IV according to claim 6, wherein said pressure bag is pumped to a predetermined pressure of about 300 mm of Hg.
